(19) United States
(12) Patent Application Publication
(10) Pub. No.: US 2019/0102314 A1
(43) Pub. Date: Apr. 4, 2019

(54) TAG CACHE ADAPTIVE POWER GATING

(71) Applicant: Intel Corporation, Santa Clara, CA (US)

(72) Inventors: Zhe Wang, Hillsboro, OR (US); Zeshan Chishti, Hillsboro, OR (US); Nagi Aboulenein, King City, OR (US); Zvika Greenfield, Kfar Sava (IL)

(21) Appl. No.: 15/721,572

(22) Filed: Sep. 29, 2017

(51) Int. Cl. G06F 12/0895; G06F 12/0873; H04W 52/22; H04W 52/24

(52) U.S. Cl. CPC G06F 12/0895; H04W 52/246; H04W 52/22; G06F 12/0873

(57) ABSTRACT

An embodiment of a semiconductor package apparatus may include technology to determine a workload characteristic for a tag cache, and adjust a power parameter for the tag cache based on the workload characteristic. Other embodiments are disclosed and claimed.

### TECHNICAL FIELD

Embodiments generally relate to memory systems, and more particularly, embodiments relate to a tag cache with adaptive power gating.

### BACKGROUND

Computing systems or platforms may utilize various memory arrangements. A two-level memory (2LM) system may include near memory (NM) and far memory (FM). A tag cache may cache tag and/or metadata information related to cache entries.

### BRIEF DESCRIPTION OF THE DRAWINGS

The various advantages of the embodiments will become apparent to one skilled in the art by reading the following specification and appended claims, and by referencing the following drawings, in which:

FIG. 1 is a block diagram of an example of an electronic processing system according to an embodiment;

FIG. 2 is a block diagram of an example of a semiconductor package apparatus according to an embodiment;

FIGS. 3A to 3D are flowcharts of an example of a method of controlling a memory according to an embodiment;

FIG. 4 is a block diagram of another example of an electronic processing system according to an embodiment;

FIG. 5 is an illustrative diagram of an example of a timeline for power gating a tag cache according to an embodiment;

FIG. 6 is a flowchart of an example of a method of power gating a tag cache according to an embodiment;

FIG. 7 is a flowchart of another example of a method of power gating a tag cache according to an embodiment; and

FIG. 8 is an illustrative graph of an example of hit rate versus workload according to an embodiment.

### DESCRIPTION OF EMBODIMENTS

Various embodiments described herein may include a memory component and/or an interface to a memory component. Such memory components may include volatile and/or nonvolatile memory. Nonvolatile memory may be a storage medium that does not require power to maintain the state of data stored by the medium. In one embodiment, the memory device may include a block addressable memory device, such as those based on NAND or NOR technologies. A memory device may also include future generation nonvolatile devices, such as a three dimensional crosspoint memory device, or other byte addressable write-in-place nonvolatile memory devices. In one embodiment, the memory device may be or may include memory devices that use chalcogenide glass, multi-threshold level NAND flash memory, NOR flash memory, single or multi-level Phase Change Memory (PCM), a resistive memory, nanowire memory, ferroelectric transistor random access memory (FeTRAM), anti-ferroelectric memory, magnetoresistive random access memory (MRAM) memory that incorporates memristor technology, resistive memory including the metal oxide base, the oxygen vacancy base and the conductive bridge Random Access Memory (CB-RAM), or spin transfer torque (STT)-MRAM, a spintronic magnetic junction memory based device, a magnetic tunneling junction (MTJ) based device, a DW (Domain Wall) and SOT (Spin Orbit Transfer) based device, a thiristor based memory device, or a combination of any of the above, or other memory. The memory device may refer to the die itself and/or to a packaged memory product. In particular embodiments, a memory component with non-volatile memory may comply with one or more standards promulgated by the Joint Electron Device Engineering Council (JEDEC), such as JESD218, JESD219, JESD220-1, JESD223B, JESD223-1, or other suitable standard (the JEDEC standards cited herein are available at jedec.org).

Volatile memory may be a storage medium that requires power to maintain the state of data stored by the medium. Non-limiting examples of volatile memory may include various types of RAM, such as dynamic random access memory (DRAM) or static random access memory (SRAM). One particular type of DRAM that may be used in a memory module is synchronous dynamic random access memory (SDRAM). In particular embodiments, DRAM of a memory component may comply with a standard promulgated by JEDEC, such as JESD79F for DDR SDRAM, JESD79-2F for DDR2 SDRAM, JESD79-3F for DDR3 SDRAM, JESD79-4A for DDR4 SDRAM, JESD209 for Low Power DDR (LPDDR), JESD209-2 for LPDDR2, JESD209-3 for LPDDR3, and JESD209-4 for LPDDR4 (these standards are available at www.jedec.org). Such standards (and similar standards) may be referred to as DDR-based standards and communication interfaces of the storage devices that implement such standards may be referred to as DDR-based interfaces.

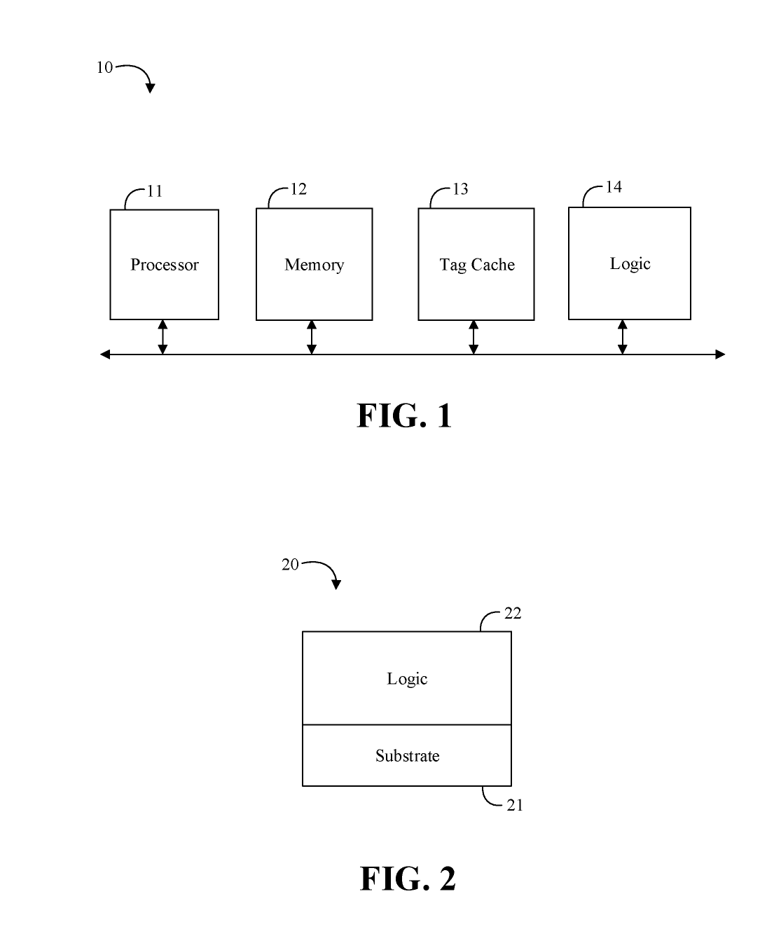

Turning now to FIG. 1, an embodiment of an electronic processing system 10 may include a processor 11, memory 12 communicatively coupled to the processor 11, a tag cache 13 communicatively coupled to the processor 11, and logic 14 communicatively coupled to the processor 11 to determine a workload characteristic for the tag cache 13, and adjust a power parameter for the tag cache 13 based on the workload characteristic. In some embodiments, the logic 14 may be configured to predict a hit rate for the tag cache 13. For example, the logic 14 may also be configured to adjust power to one or more ways of the tag cache 13 based on the predicted hit rate for the tag cache 13.

In some embodiments, the logic 14 may be configured to predict a first hit rate for a first set of ways of the tag cache 13, compare the predicted first hit rate for the first set of ways to a first threshold, and power gate a second set of ways of the tag cache 13 if the predicted first hit rate exceeds the first threshold. For example, the logic 14 may be further configured to predict a second hit rate for a third set of ways of the tag cache 13, compare the predicted second hit rate for the third set of ways to a second threshold, and power gate a fourth set of ways of the tag cache 13 if the predicted second hit rate exceeds the second threshold. Some embodiments may power gate a set of ways by turning off power to the set of ways, by reducing power to the set of ways, by putting the set of ways into a reduced power mode, disabling the set of ways, etc. In any of the embodiments herein, the tag cache may be configured to cache metadata and tag information of a near memory of a 2LM system. In some embodiments, the tag cache 13 and/or the logic 14 may be located in, or co-located with, various components, including the processor 11 (e.g., on a same die). Without being limited to particular implementations, in some embodiments the tag cache 13 may be a SRAM structure which may be located in a 2LM controller.

Embodiments of each of the above processor 11, memory 12, tag cache 13, logic 14, and other system components may be implemented in hardware, software, or any suitable combination thereof. For example, hardware implementations may include configurable logic such as, for example, programmable logic arrays (PLAs), field programmable gate arrays (FPGAs), complex programmable logic devices (CPLDs), or fixed-functionality logic hardware using circuit technology such as, for example, application specific integrated circuit (ASIC), complementary metal oxide semiconductor (CMOS) or transistor-transistor logic (TTL) technology, or any combination thereof

Alternatively, or additionally, all or portions of these components may be implemented in one or more modules as a set of logic instructions stored in a machine- or computer-readable storage medium such as random access memory (RAM), read only memory (ROM), programmable ROM (PROM), firmware, flash memory, etc., to be executed by a processor or computing device. For example, computer program code to carry out the operations of the components may be written in any combination of one or more operating system (OS) applicable/appropriate programming languages, including an object-oriented programming language such as PYTHON, PERL, JAVA, SMALLTALK, C++, C# or the like and conventional procedural programming languages, such as the “C” programming language or similar programming languages. For example, the memory 12, persistent storage media, or other system memory may store a set of instructions which when executed by the processor 11 cause the system 10 to implement one or more components, features, or aspects of the system 10 (e.g., the logic 14, determining a workload characteristic for a tag cache, adjusting a power parameter for the tag cache based on the workload characteristic, etc.).

Turning now to FIG. 2, an embodiment of a semiconductor package apparatus 20 may include a substrate 21, and logic 22 coupled to the substrate 21, where the logic 22 is at least partly implemented in one or more of configurable logic and fixed-functionality hardware logic. The logic 22 coupled to the substrate 21 may be configured to determine a workload characteristic for a tag cache, and adjust a power parameter for the tag cache based on the workload characteristic. In some embodiments, the logic 22 may be configured to predict a hit rate for the tag cache. For example, the logic 22 may also be configured to adjust power to one or more ways of the tag cache based on the predicted hit rate for the tag cache.

In some embodiments, the logic 22 may be configured to predict a first hit rate for a first set of ways of the tag cache, compare the predicted first hit rate for the first set of ways to a first threshold, and power gate a second set of ways of the tag cache if the predicted first hit rate exceeds the first threshold. For example, the logic 22 may also be configured to predict a second hit rate for a third set of ways of the tag cache, compare the predicted second hit rate for the third set of ways to a second threshold, and power gate a fourth set of ways of the tag cache if the predicted second hit rate exceeds the second threshold. Some embodiments may power gate a set of ways by turning off power to the set of ways, by reducing power to the set of ways, by putting the set of ways into a reduced power mode, disabling the set of ways, etc. The tag cache may be configured to cache metadata and tag information of a near memory of a 2LM system.

Embodiments of logic 22, and other components of the apparatus 20, may be implemented in hardware, software, or any combination thereof including at least a partial implementation in hardware. For example, hardware implementations may include configurable logic such as, for example, PLAs, FPGAs, CPLDs, or fixed-functionality logic hardware using circuit technology such as, for example, ASIC, CMOS, or TTL technology, or any combination thereof. Additionally, portions of these components may be implemented in one or more modules as a set of logic instructions stored in a machine- or computer-readable storage medium such as RAM, ROM, PROM, firmware, flash memory, etc., to be executed by a processor or computing device. For example, computer program code to carry out the operations of the components may be written in any combination of one or more OS applicable/appropriate programming languages, including an object-oriented programming language such as PYTHON, PERL, JAVA, SMALLTALK, C++, C# or the like and conventional procedural programming languages, such as the “C” programming language or similar programming languages.

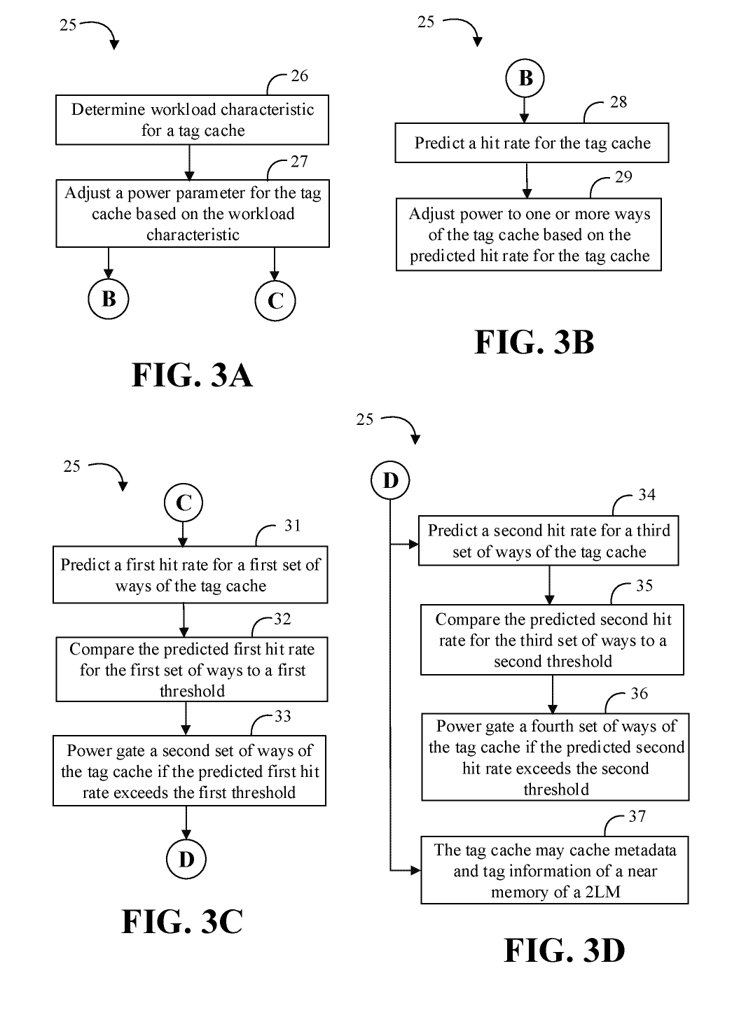

Turning now to FIGS. 3A to 3D, an embodiment of a method 25 of controlling a memory may include determining workload characteristic for a tag cache at block 26, and adjusting a power parameter for the tag cache based on the workload characteristic at block 27. Some embodiments of the method 25 may include predicting a hit rate for the tag cache at block 28, and adjusting power to one or more ways of the tag cache based on the predicted hit rate for the tag cache at block 29.

In some embodiments, the method 25 may include predicting a first hit rate for a first set of ways of the tag cache at block 31, comparing the predicted first hit rate for the first set of ways to a first threshold at block 32, and power gating a second set of ways of the tag cache if the predicted first hit rate exceeds the first threshold at block 33. For example, the method 25 may also include predicting a second hit rate for a third set of ways of the tag cache at block 34, comparing the predicted second hit rate for the third set of ways to a second threshold at block 35, and power gating a fourth set of ways of the tag cache if the predicted second hit rate exceeds the second threshold at block 36. In some embodiments, power gating a set of ways may include turning off power to the set of ways, reducing power to the set of ways, putting the set of ways into a reduced power mode, disabling the set of ways, etc. In some embodiments of the method 25, the tag cache may cache metadata and tag information of a near memory of a 2LM at block 37.

Embodiments of the method 25 may be implemented in a system, apparatus, computer, device, etc., for example, such as those described herein. More particularly, hardware implementations of the method 25 may include configurable logic such as, for example, PLAs, FPGAs, CPLDs, or in fixed-functionality logic hardware using circuit technology such as, for example, ASIC, CMOS, or TTL technology, or any combination thereof Alternatively, or additionally, the method 25 may be implemented in one or more modules as a set of logic instructions stored in a machine- or computer-readable storage medium such as RAM, ROM, PROM, firmware, flash memory, etc., to be executed by a processor or computing device. For example, computer program code to carry out the operations of the components may be written in any combination of one or more OS applicable/appropriate programming languages, including an object-oriented programming language such as PYTHON, PERL, JAVA, SMALLTALK, C++, C# or the like and conventional procedural programming languages, such as the “C” programming language or similar programming languages.

For example, the method 25 may be implemented on a computer readable medium as described in connection with Examples 19 to 24 below. Embodiments or portions of the method 25 may be implemented in firmware, applications (e.g., through an application programming interface (API)), or driver software running on an operating system (OS).

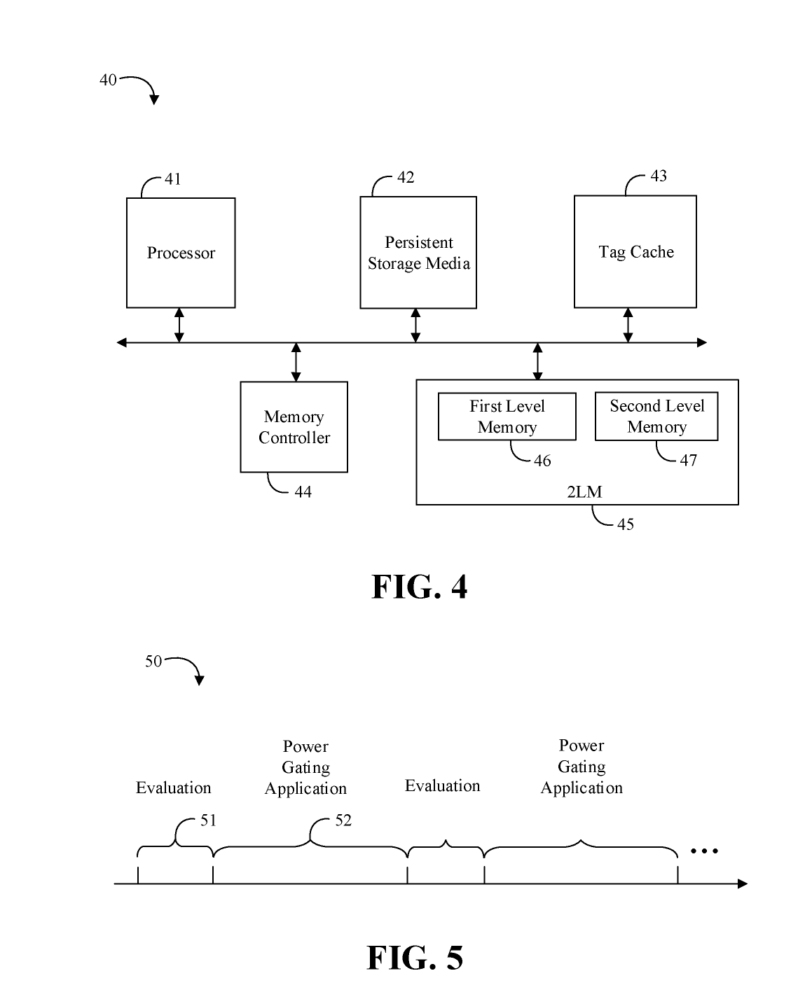

Turning now to FIG. 4, an embodiment of an electronic processing system 40 may include a processor 41, persistent storage media 42 communicatively coupled to the processor 41, a tag cache 43 to cache tag information, and a memory controller 44 communicatively coupled to the processor 41 and the tag cache 43 to determine a workload characteristic for the tag cache 43, and adjust a power parameter for the tag cache 43 based on the workload characteristic. In some embodiments, the memory controller 44 may be configured to predict a hit rate for the tag cache 43. For example, the memory controller 44 may also be configured to adjust power to one or more ways of the tag cache 43 based on the predicted hit rate for the tag cache 43. In some embodiments, the memory controller 44 may be configured to predict a first hit rate for a first set of ways of the tag cache 43, compare the predicted first hit rate for the first set of ways to a first threshold, and power gate a second set of ways of the tag cache 43 if the predicted first hit rate exceeds the first threshold. For example, the memory controller 44 may also be configured to predict a second hit rate for a third set of ways of the tag cache 43, compare the predicted second hit rate for the third set of ways to a second threshold, and power gate a fourth set of ways of the tag cache 43 if the predicted second hit rate exceeds the second threshold. Some embodiments may power gate a set of ways by turning off power to the set of ways, by reducing power to the set of ways, by putting the set of ways into a reduced power mode, disabling the set of ways, etc.

The system 40 may further include a two-level memory (2LM) 45 including a first level memory 46 and a second level memory 47. The tag cache 43 may be configured to cache metadata and tag information of a near memory of the 2LM 45. In various embodiments, any of the first level memory 46 and the second level memory 47 may include NVM and/or volatile memory. For example, the 2LM 45 may correspond to system memory or main memory having a near memory and a far memory. The first level memory 46 may correspond to the near memory and include smaller, faster DRAM. The second level memory 47 may correspond to the far memory and include larger storage capacity NVM (e.g. a byte-addressable 3D crosspoint memory). For example, the tag cache 43 may cache tag and/or metadata information of the near memory (e.g., the first level memory 46).

Embodiments of the processor 41, the persistent storage media 42, the tag cache 43, the memory controller 44, the 2LM 45, the first level memory 46, the second level memory 47, and other components of the system 40, may be implemented in hardware, software, or any combination thereof including at least a partial implementation in hardware. For example, hardware implementations may include configurable logic such as, for example, PLAs, FPGAs, CPLDs, or fixed-functionality logic hardware using circuit technology such as, for example, ASIC, CMOS, or TTL technology, or any combination thereof. Additionally, portions of these components may be implemented in one or more modules as a set of logic instructions stored in a machine- or computer-readable storage medium such as RAM, ROM, PROM, firmware, flash memory, etc., to be executed by a processor or computing device. For example, computer program code to carry out the operations of the components may be written in any combination of one or more OS applicable/appropriate programming languages, including an object-oriented programming language such as PYTHON, PERL, JAVA, SMALLTALK, C++, C# or the like and conventional procedural programming languages, such as the “C” programming language or similar programming languages.

Some embodiments may advantageously provide adaptive tag cache power gating for a client 2LM platform. Without being limited to particular implementations, in some embodiments a tag cache may be a SRAM structure which may be located in a 2LM controller. The tag cache may be used to cache the metadata and tag information of a near memory (NM) in a 2LM system. In some systems, the power consumption of the tag cache may be significant. Some other systems may reduce power consumption of the tag cache based on system states (e.g., statically). For example, if the system is in a sleep mode, the whole tag cache will be turned off to save power. Some embodiments may advantageously dynamically power gate the tag cache according to program execution behavior. If a workload has a small footprint such that the tags for the workload fit into one-fourth (¼) of the tag cache capacity, for example, some embodiments may apply power gating to three-fourths (¾)of the tag cache capacity. Such tag cache power gating in accordance with some embodiments may advantageously reduce about three-fourths (¾) of the leakage power consumption. Some embodiments may also dynamically detect the size of the workload, and adjust or optimize the power gating applied to the tag cache based on the dynamically detected workload size. Some embodiments may provide an adaptive tag cache power gating technique that may dynamically power gate the tag cache ways according to the program running behavior to advantageously reduce the tag cache power consumption.

Some embodiments may also have little or no significant degradation of the tag cache hit rate while saving power. For example, some embodiments may predict the hit rate of a tag cache with various capacities enabled. For a tag cache with a total 4 MB capacity and a 16-way tag cache set, if the hit rate of a 1 MB tag cache capacity is larger than a 4-way threshold, then some embodiments may apply power gating to twelve (12) tag cache ways in each set. If the predicted hit rate is too low with a 1 MB tag cache capacity, some embodiments may predict the hit rate for a 2 MB tag cache capacity. If the predicted hit rate of the 2 MB tag cache capacity is larger than an 8-way threshold, then some embodiments may apply power gating to eight (8) tag cache ways in each set. Advantageously, some embodiments may save tag cache power consumption by adaptively power gating the tag cache ways without hurting the system performance (e.g., by selecting desired minimum hit rates for the thresholds).

Turning now to FIG. 5, an embodiment of a general workflow 50 may include an evaluation phase 51 followed by a power gating application phase 52, which then may repeat. During the evaluation phase 51, the workload may be analyzed for relevant information about the current workload and/or the future workload (e.g., particularly with respect to the workloads' utilization of the tag cache). During the application phase 52, power settings for the tag cache may be adjusted based on the evaluation. The workload may then be re-evaluated in the next evaluation phase. For example, such re-evaluation may be performed periodically (e.g., based on a period of elapsed time, a count of execution cycles, etc.) or may be triggered by an event (e.g., based on a change in the workload, a newly loaded executable, a memory access request, etc.).

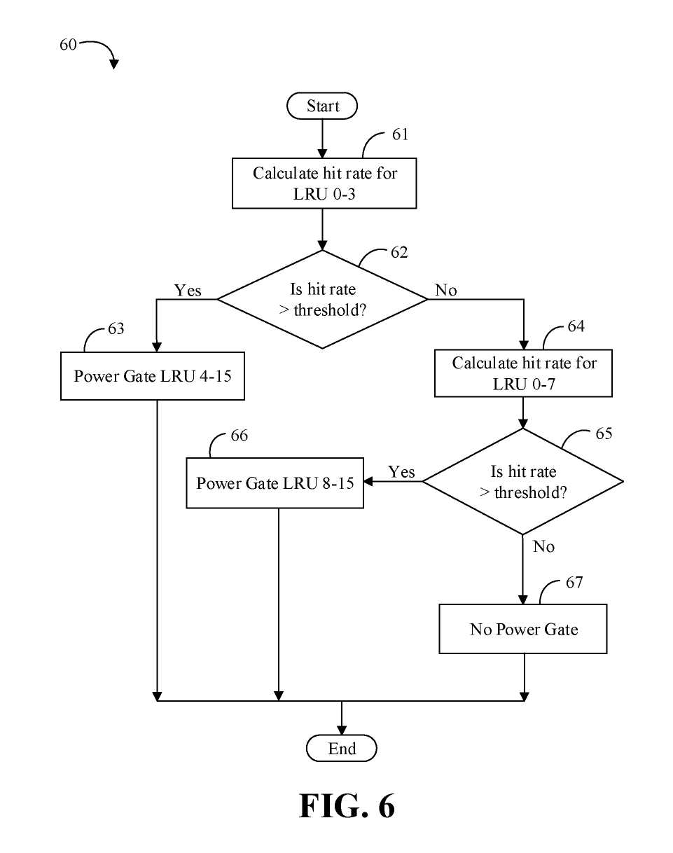

Turning now to FIG. 6, some embodiments may dynamically provide power gating to the tag cache ways according to the workload size. In some embodiments, the workload size may be predicted by evaluating the hit rates of using various capacities of the tag cache. For a 16-way tag cache set, some embodiments may calculate the number of requests that hit in various sizes of the tag cache way sets. An embodiment of a method 60 of power gating a 16-way tag cache may include calculating a hit rate for least recently used (LRU) positions 0-3 at block 61, and determining if the hit rate of LRU positions 0-3 is larger than a threshold at block 62. If so, then the method 60 may choose to power gate twelve (12) tag cache ways in each set (e.g., LRU positions 4-15) at block 63. If the hit rate of LRU positions 0-3 is less than or equal to the threshold at block 62, the method 60 may then calculate the hit rate for LRU positions 0-7 at block 64, and determine if the hit rate of LRU positions 0-7 is larger than the threshold at block 65. If so, the method 60 may choose to power gate eight (8) tag cache ways in each set (e.g., LRU positions 8-15) at block 66. If the hit rate of LRU positions 0-7 is less than or equal to the threshold at block 66, the method 60 may not apply power gating to the tag cache at block 67. Some embodiments may utilize a fine grain tag cache replacement technique which has distinct recency levels. For example, some embodiments may utilize a 1-bit tree-pseudo LRU (PLRU) replacement policy.

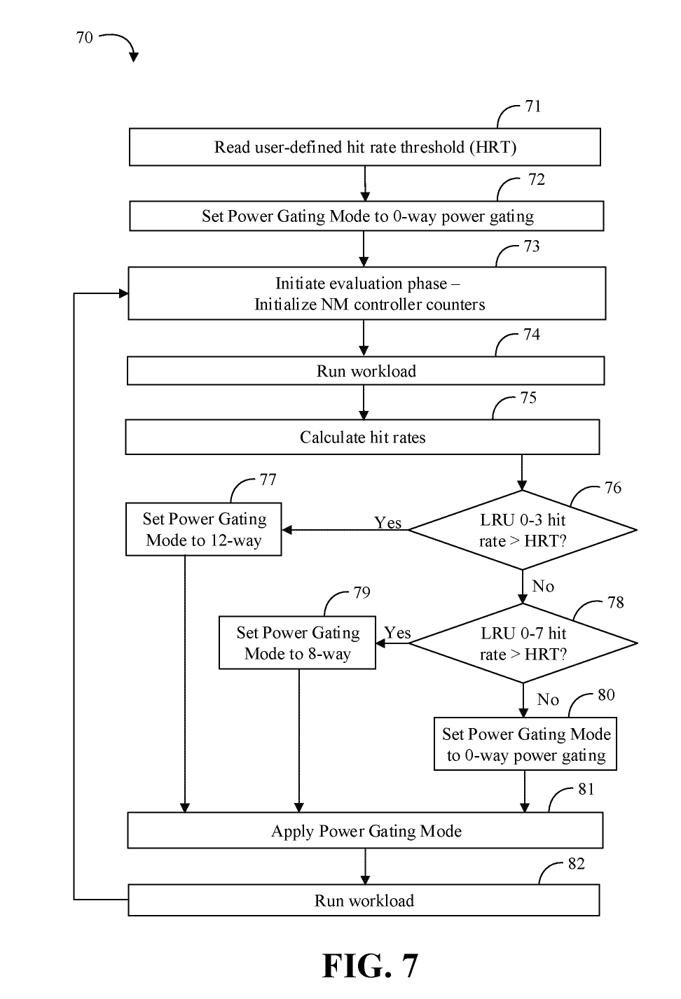

Turning now to FIG. 7, an embodiment of a method 70 of power gating a tag cache may include reading a user-defined hit rate threshold (HRT) at block 71, setting an initial power gating scheme to 0-way power gating at block 72, and initiating an evaluation phase by initializing NM controller counter values at block 73 (e.g., a LRU0-3 hit counter, a LRU 0-7 hit counter, a LRU 0-15 hit counter, and a memory read request counter). The method 70 may then run the workload at block 74. During runtime, the counters in the NM controller may be used to count the number of read requests that hit within the LRU positions 0-3, 0-7 , and 0-15, and also the total number of memory read requests. At the end of the evaluation phase, the method 70 may calculate the various hit rates at block 75 (e.g., an LRU 0-3 hit rate, a LRU 0-7 hit rate, and a LRU 0-15 hit rate) and thereafter determine how many sets of ways of the tag cache are needed to support the desired hit rate.

If the hit rate of the read requests within LRU positions 0-3 is larger than the user defined threshold HRT at block 76, the method 70 may set the power gating mode to 12-way power gating at block 77. Otherwise, the method 70 may determine if the hit rate of the read requests within LRU position 0-7 is larger than the user defined threshold HRT at block 78 and, if so, set the power gating mode to 8-way power gating at block 79. If the hit rate of the read requests within LRU position 0-7 is not larger than the user defined threshold HRT at block 78, the method 70 may set the power gating mode to 0-way power gating at block 80. During an application phase, the method 70 may apply the current power gating mode at block 81, and run the workload with the applied power gating mode at block 82 until the next evaluation starts at block 73.

At the end of an evaluation phase, if the hit rate of the LRU position 0-3 is larger than the threshold HRT, for example, then power gating will be applied to 12 ways in each tag cache set during the next application phase. The tags in the LRU position 0-3 may be copied to the ways with way identification (wayID) 0-3 and the other ways with wayID 4-15 may be power gated. During a subsequent evaluation phase, the hit rates may be re-evaluated and the results of the re-evaluation may be applied to the following application phase.

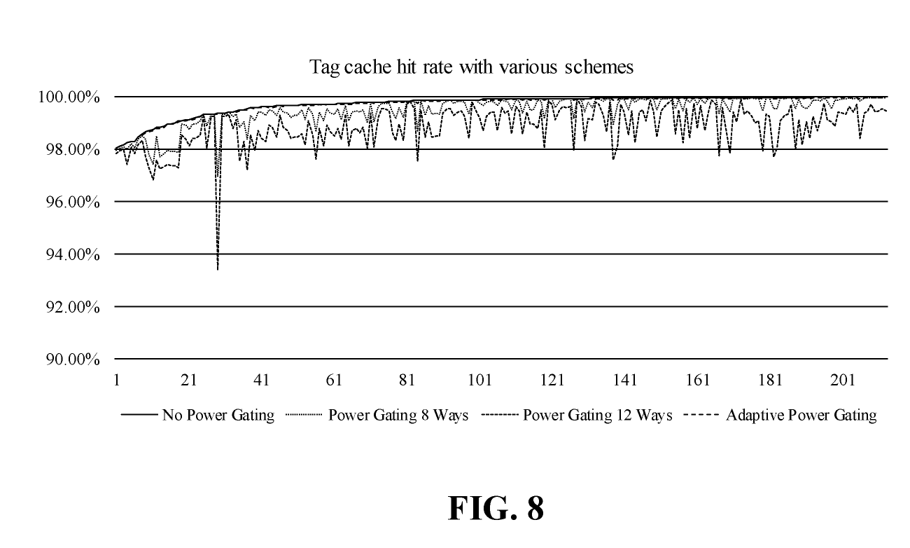

Turning now to FIG. 8, a graph of workload versus hit rate shows results for different workloads with no power gating (e.g., all ways available in each tag cache set), statically power gating 8 ways (e.g., always power gating 8 ways in each tag cache set), statically power gating 12 ways (e.g., always power gating 12 ways in each tag cache set), and adaptive power gating (e.g., adjusting the power gating for the tag cache based on the workload in accordance with an embodiment where the hit rate threshold is set to 97%). The graph shows that adaptive power gating in accordance with some embodiments may achieve a similar tag cache hit rate as compared to no power gating, while advantageously providing power savings. Some workloads may have cache hit rates that are well supported by a set of 4 ways over their entire execution time (e.g., or over a number of evaluation phases). Some embodiments of an adaptive power gating technique for the tag cache may select 12-way power gating for those workloads over their entire execution time, advantageously providing a similar tag cache hit rate as compared to no power gating while providing power savings over the entire execution time of those workloads. The results shown in FIG. 8 may be considered as illustrative results for an example workload. Actual results may vary depending on the particular embodiment and the particular workload.

### ADDITIONAL NOTES AND EXAMPLES

Example 1 may include an electronic processing system, comprising a processor, memory communicatively coupled to the processor, a tag cache communicatively coupled to the processor, and logic communicatively coupled to the processor to determine a workload characteristic for the tag cache, and adjust a power parameter for the tag cache based on the workload characteristic.

Example 2 may include the system of Example 1, wherein the logic is further to predict a hit rate for the tag cache.

Example 3 may include the system of Example 2, wherein the logic is further to adjust power to one or more ways of the tag cache based on the predicted hit rate for the tag cache.

Example 4 may include the system of Example 1, wherein the logic is further to predict a first hit rate for a first set of ways of the tag cache, compare the predicted first hit rate for the first set of ways to a first threshold, and power gate a second set of ways of the tag cache if the predicted first hit rate exceeds the first threshold.

Example 5 may include the system of Example 4, wherein the logic is further to predict a second hit rate for a third set of ways of the tag cache, compare the predicted second hit rate for the third set of ways to a second threshold, and power gate a fourth set of ways of the tag cache if the predicted second hit rate exceeds the second threshold.

Example 6 may include the system of any of Examples 1 to 5, wherein the tag cache is to cache metadata and tag information of a near memory of a two-level memory.

Example 7 may include a semiconductor package apparatus, comprising a substrate, and logic coupled to the substrate, wherein the logic is at least partly implemented in one or more of configurable logic and fixed-functionality hardware logic, the logic coupled to the substrate to determine a workload characteristic for a tag cache, and adjust a power parameter for the tag cache based on the workload characteristic.

Example 8 may include the apparatus of Example 7, wherein the logic is further to predict a hit rate for the tag cache.

Example 9 may include the apparatus of Example 8, wherein the logic is further to adjust power to one or more ways of the tag cache based on the predicted hit rate for the tag cache.

Example 10 may include the apparatus of Example 7, wherein the logic is further to predict a first hit rate for a first set of ways of the tag cache, compare the predicted first hit rate for the first set of ways to a first threshold, and power gate a second set of ways of the tag cache if the predicted first hit rate exceeds the first threshold.

Example 11 may include the apparatus of Example 10, wherein the logic is further to predict a second hit rate for a third set of ways of the tag cache, compare the predicted second hit rate for the third set of ways to a second threshold, and power gate a fourth set of ways of the tag cache if the predicted second hit rate exceeds the second threshold.

Example 12 may include the apparatus of any of Examples 7 to 11, wherein the tag cache is to cache metadata and tag information of a near memory of a two-level memory.

Example 13 may include a method of controlling a memory, comprising determining workload characteristic for a tag cache, and adjusting a power parameter for the tag cache based on the workload characteristic.

Example 14 may include the method of Example 13, further comprising predicting a hit rate for the tag cache.

Example 15 may include the method of Example 14, further comprising adjusting power to one or more ways of the tag cache based on the predicted hit rate for the tag cache.

Example 16 may include the method of Example 13, further comprising predicting a first hit rate for a first set of ways of the tag cache, comparing the predicted first hit rate for the first set of ways to a first threshold, and power gating a second set of ways of the tag cache if the predicted first hit rate exceeds the first threshold.

Example 17 may include the method of Example 16, further comprising predicting a second hit rate for a third set of ways of the tag cache, comparing the predicted second hit rate for the third set of ways to a second threshold, and power gating a fourth set of ways of the tag cache if the predicted second hit rate exceeds the second threshold.

Example 18 may include the method of any of Examples 13 to 17, wherein the tag cache is to cache metadata and tag information of a near memory of a two-level memory.

Example 19 may include at least one computer readable medium, comprising a set of instructions, which when executed by a computing device, cause the computing device to determine a workload characteristic for a tag cache, and adjust a power parameter for the tag cache based on the workload characteristic.

Example 20 may include the at least one computer readable medium of Example 19, comprising a further set of instructions, which when executed by the computing device, cause the computing device to predict a hit rate for the tag cache.

Example 21 may include the at least one computer readable medium of Example 20, comprising a further set of instructions, which when executed by the computing device, cause the computing device to adjust power to one or more ways of the tag cache based on the predicted hit rate for the tag cache.

Example 22 may include the at least one computer readable medium of Example 19, comprising a further set of instructions, which when executed by the computing device, cause the computing device to predict a first hit rate for a first set of ways of the tag cache, compare the predicted first hit rate for the first set of ways to a first threshold, and power gate a second set of ways of the tag cache if the predicted first hit rate exceeds the first threshold.

Example 23 may include the at least one computer readable medium of Example 22, comprising a further set of instructions, which when executed by the computing device, cause the computing device to predict a second hit rate for a third set of ways of the tag cache, compare the predicted second hit rate for the third set of ways to a second threshold, and power gate a fourth set of ways of the tag cache if the predicted second hit rate exceeds the second threshold.

Example 24 may include the at least one computer readable medium of any of Examples 19 to 23, wherein the tag cache is to cache metadata and tag information of a near memory of a two-level memory.

Example 25 may include a memory controller apparatus, comprising means for determining workload characteristic for a tag cache, and means for adjusting a power parameter for the tag cache based on the workload characteristic.

Example 26 may include the apparatus of Example 25, further comprising means for predicting a hit rate for the tag cache.

Example 27 may include the apparatus of Example 26, further comprising means for adjusting power to one or more ways of the tag cache based on the predicted hit rate for the tag cache.

Example 28 may include the apparatus of Example 25, further comprising means for predicting a first hit rate for a first set of ways of the tag cache, means for comparing the predicted first hit rate for the first set of ways to a first threshold, and means for power gating a second set of ways of the tag cache if the predicted first hit rate exceeds the first threshold.

Example 29 may include the apparatus of Example 28, further comprising means for predicting a second hit rate for a third set of ways of the tag cache, means for comparing the predicted second hit rate for the third set of ways to a second threshold, and means for power gating a fourth set of ways of the tag cache if the predicted second hit rate exceeds the second threshold.

Example 30 may include the apparatus of any of Examples 25 to 29, wherein the tag cache is to cache metadata and tag information of a near memory of a two-level memory.

Embodiments are applicable for use with all types of semiconductor integrated circuit (“IC”) chips. Examples of these IC chips include but are not limited to processors, controllers, chipset components, programmable logic arrays (PLAs), memory chips, network chips, systems on chip (SoCs), SSD/NAND controller ASICs, and the like. In addition, in some of the drawings, signal conductor lines are represented with lines. Some may be different, to indicate more constituent signal paths, have a number label, to indicate a number of constituent signal paths, and/or have arrows at one or more ends, to indicate primary information flow direction. This, however, should not be construed in a limiting manner. Rather, such added detail may be used in connection with one or more exemplary embodiments to facilitate easier understanding of a circuit. Any represented signal lines, whether or not having additional information, may actually comprise one or more signals that may travel in multiple directions and may be implemented with any suitable type of signal scheme, e.g., digital or analog lines implemented with differential pairs, optical fiber lines, and/or single-ended lines.

Example sizes/models/values/ranges may have been given, although embodiments are not limited to the same. As manufacturing techniques (e.g., photolithography) mature over time, it is expected that devices of smaller size could be manufactured. In addition, well known power/ground connections to IC chips and other components may or may not be shown within the figures, for simplicity of illustration and discussion, and so as not to obscure certain aspects of the embodiments. Further, arrangements may be shown in block diagram form in order to avoid obscuring embodiments, and also in view of the fact that specifics with respect to implementation of such block diagram arrangements are highly dependent upon the platform within which the embodiment is to be implemented, i.e., such specifics should be well within purview of one skilled in the art. Where specific details (e.g., circuits) are set forth in order to describe example embodiments, it should be apparent to one skilled in the art that embodiments can be practiced without, or with variation of, these specific details. The description is thus to be regarded as illustrative instead of limiting.

The term “coupled” may be used herein to refer to any type of relationship, direct or indirect, between the components in question, and may apply to electrical, mechanical, fluid, optical, electromagnetic, electromechanical or other connections. In addition, the terms “first”, “second”, etc. may be used herein only to facilitate discussion, and carry no particular temporal or chronological significance unless otherwise indicated.

As used in this application and in the claims, a list of items joined by the term “one or more of” may mean any combination of the listed terms. For example, the phrase “one or more of A, B, and C” and the phrase “one or more of A, B, or C” both may mean A; B; C; A and B; A and C; B and C; or A, B and C.

Those skilled in the art will appreciate from the foregoing description that the broad techniques of the embodiments can be implemented in a variety of forms. Therefore, while the embodiments have been described in connection with particular examples thereof, the true scope of the embodiments should not be so limited since other modifications will become apparent to the skilled practitioner upon a study of the drawings, specification, and following claims.

We claim:

1. An electronic processing system, comprising:
a processor;
memory communicatively coupled to the processor;
a tag cache communicatively coupled to the processor; and
logic communicatively coupled to the processor to:
determine a workload characteristic for the tag cache, and
adjust a power parameter for the tag cache based on the workload characteristic.

2. The system of claim 1, wherein the logic is further to:
predict a hit rate for the tag cache.

3. The system of claim 2, wherein the logic is further to:
adjust power to one or more ways of the tag cache based on the predicted hit rate for the tag cache.

4. The system of claim 1, wherein the logic is further to:
predict a first hit rate for a first set of ways of the tag cache;
compare the predicted first hit rate for the first set of ways to a first threshold; and
power gate a second set of ways of the tag cache if the predicted first hit rate exceeds the first threshold.

5. The system of claim 4, wherein the logic is further to:
predict a second hit rate for a third set of ways of the tag cache;
compare the predicted second hit rate for the third set of ways to a second threshold; and
power gate a fourth set of ways of the tag cache if the predicted second hit rate exceeds the second threshold.

6. The system of claim 1, wherein the tag cache is to cache metadata and tag information of a near memory of a two-level memory.

7. A semiconductor package apparatus, comprising:
a substrate; and
logic coupled to the substrate, wherein the logic is at least partly implemented in one or more of configurable logic and fixed-functionality hardware logic, the logic coupled to the substrate to:
determine a workload characteristic for a tag cache, and
adjust a power parameter for the tag cache based on the workload characteristic.

8. The apparatus of claim 7, wherein the logic is further to:
predict a hit rate for the tag cache.

9. The apparatus of claim 8, wherein the logic is further to:
adjust power to one or more ways of the tag cache based on the predicted hit rate for the tag cache.

10. The apparatus of claim 7, wherein the logic is further to:
predict a first hit rate for a first set of ways of the tag cache;
compare the predicted first hit rate for the first set of ways to a first threshold; and
power gate a second set of ways of the tag cache if the predicted first hit rate exceeds the first threshold.

11. The apparatus of claim 10, wherein the logic is further to:
predict a second hit rate for a third set of ways of the tag cache;
compare the predicted second hit rate for the third set of ways to a second threshold; and
power gate a fourth set of ways of the tag cache if the predicted second hit rate exceeds the second threshold.

12. The apparatus of claim 7, wherein the tag cache is to cache metadata and tag information of a near memory of a two-level memory.

13. A method of controlling a memory, comprising:
determining workload characteristic for a tag cache; and
adjusting a power parameter for the tag cache based on the workload characteristic.

14. The method of claim 13, further comprising:
predicting a hit rate for the tag cache.

15. The method of claim 14, further comprising:
adjusting power to one or more ways of the tag cache based on the predicted hit rate for the tag cache.

16. The method of claim 13, further comprising:
predicting a first hit rate for a first set of ways of the tag cache;
comparing the predicted first hit rate for the first set of ways to a first threshold; and
power gating a second set of ways of the tag cache if the predicted first hit rate exceeds the first threshold.

17. The method of claim 16, further comprising:
predicting a second hit rate for a third set of ways of the tag cache;
comparing the predicted second hit rate for the third set of ways to a second threshold; and
power gating a fourth set of ways of the tag cache if the predicted second hit rate exceeds the second threshold.

18. The method of claim 13, wherein the tag cache is to cache metadata and tag information of a near memory of a two-level memory.

19. At least one computer readable medium, comprising a set of instructions, which when executed by a computing device, cause the computing device to:
determine a workload characteristic for a tag cache; and
adjust a power parameter for the tag cache based on the workload characteristic.

20. The at least one computer readable medium of claim 19, comprising a further set of instructions, which when executed by the computing device, cause the computing device to:
predict a hit rate for the tag cache.

21. The at least one computer readable medium of claim 20, comprising a further set of instructions, which when executed by the computing device, cause the computing device to:
adjust power to one or more ways of the tag cache based on the predicted hit rate for the tag cache.

22. The at least one computer readable medium of claim 19, comprising a further set of instructions, which when executed by the computing device, cause the computing device to:
predict a first hit rate for a first set of ways of the tag cache;
compare the predicted first hit rate for the first set of ways to a first threshold; and
power gate a second set of ways of the tag cache if the predicted first hit rate exceeds the first threshold.

23. The at least one computer readable medium of claim 22, comprising a further set of instructions, which when executed by the computing device, cause the computing device to:
predict a second hit rate for a third set of ways of the tag cache;
compare the predicted second hit rate for the third set of ways to a second threshold; and
power gate a fourth set of ways of the tag cache if the predicted second hit rate exceeds the second threshold.

24. The at least one computer readable medium of claim 19, wherein the tag cache is to cache metadata and tag information of a near memory of a two-level memory.
